(19) United States
(12) Patent Application Publication
(10) Pub. No.: US 2012/0260666 A1
(43) Pub. Date: Oct. 18, 2012

(54) MULTI-FUEL COMBUSTION SYSTEM

(76) Inventors: Vinayak V. Barve, Orlando, FL (US); Timothy A. Fox, Hamilton (CA); Jianfan Wu, Orlando, FL (US); Ulrich Wörz, Oviedo, FL (US); Jaap Van Kampen, Roermond (NL)

(21) Appl. No.: 13/502,555

(22) PCT Filed: Oct. 20, 2010
(86) PCT No.: PCT/EP2010/065764

§ 371 Date: Jun. 26, 2012

Related U.S. Application Data
(62) Division of application No. 12/581,978, filed on Oct. 20, 2009.

(51) Int. Cl. F23R 3/36; F02C 3/20

(52) U.S. Cl. 60/776; 60/39.463; 60/746

(57) ABSTRACT

A multi-fuel combustion system is provided. The system includes a combustor basket adapted to combust at least two type of fuels. The combustor basket includes a circumferential wall with a plurality of openings. The combustion system further includes a first conduit adapted to provide a first type of fuel directly to the combustor basket and a second conduit adapted to provide a second type of fuel directly to the combustor basket. The combustion system also may include a third conduit adapted to inject at least one of the first type of fuel and the second type of fuel through the openings into the combustor basket.

### CROSS REFERENCE TO RELATED APPLICATIONS

This application is the U.S. National Stage of International Application No. PCT/EP2010/065764, filed Oct. 20, 2010 and claims the benefit thereof. The International Application claims the benefits of US application No. 12/581,978 filed Oct. 20, 2009. All of the applications are incorporated by reference herein in their entirety.

### FIELD OF INVENTION

The present invention lies in the field of combustion turbines in particular for generating electrical energy and more particularly, to combustor baskets employed therein.

### BACKGROUND OF INVENTION

Future energy demand, scarcity of available fuels and environmental regulations put pressure on power plant producers to come up with solutions for safe, efficient and clean ways to generate power. The scarcity of fuels mainly applies to oil and to a lesser extend to natural gas. With an availability of coal in abundance, electricity production from coal is mostly done using steam power plants. A cleaner and more efficient option to generate power from coals is to use them in an integrated gasification combine cycle (IGCC). In an IGCC, coals are first gasified to yield syngas, consisting mainly of CO (carbon monoxide) and H₂ (hydrogen).

Syngas typically has a significantly lower calorific value as compared to conventional natural gas fuels. By removing the CO content from the syngas prior to combusting it, one also has an effective means for CO₂ (carbon-dioxide) capture. The IGCC concept with pre-combustion CO₂ capture is one of the most cost-effective ways to produce electricity and avoid the emission of CO₂ in the future. The economical potential of the IGCC plant with CO₂ capture can increase even further when natural gas prices rise faster than expected or with increased carbon tax regulation.

Due to the low calorific value and high hydrogen content, the combustion of syngas fuels requires the development of adapted or completely new combustion systems which are able to handle the wide range of syngas fuels, and produce little emissions and can handle the high reactivity of the fuels.

The syngas fuel composition depends on the type of gasifier used and on whether or not the CO is separated from the fuel. Besides syngas fuels, the combustion system might run on a second conventional fuel for backup and start up. The ideal possibility is to have all the different types of fuels combusted in a stable way by one combustion system. To increase the efficiency and compensate for the efficiency loss due to the gasifier and CO₂ separation techniques, the trend will be to increase pressure and turbine inlet temperatures, even beyond values where currently natural gas experience is available. With these increasing pressures and temperatures, it becomes even more important to design a combustion system that is able to combust the syngas and hydrogen fuel, as danger for burner overheating and thermo acoustic excitation typically increases with pressure and temperature.

### SUMMARY OF INVENTION

In view of the foregoing, an embodiment herein includes a multi-fuel combustion system comprising: a combustor basket adapted to combust at least two type of fuels, said combustor basket having a circumferential wall comprising a plurality of openings; a first conduit adapted to provide a first type of fuel directly to the combustor basket; a second conduit adapted to provide a second type of fuel directly to the combustor basket; and a third conduit adapted to inject at least one of the first type of fuel and the second type of fuel trough the openings into the combustor basket. Within the combustion system third conduit 25 is just an optional choice.

In view of the foregoing, another embodiment herein includes a method of operating a multi-fuel combustion system comprising a first phase and a second phase, wherein the first phase comprises: providing ignition to a combustor basket to ignite a first type of fuel, where the first type of fuel is supplied to the combustor basket through a first conduit; supplying steam to the first conduit in addition to the first type of fuel and supplying steam to the second conduit after the ignition; and wherein the second phase comprises: supplying a second type of fuel to the combustor basket after ignition of the first fuel through the second conduit, while stopping the supply of the first fuel.

### BRIEF DESCRIPTION OF THE DRAWINGS

The present invention is further described hereinafter with reference to illustrated embodiments shown in the accompanying drawings, in which:

FIG. 1 illustrates a longitudinal cross-section of the multi-fuel combustion system,

FIG. 2 shows fuel injector holes at the region of nozzle of the first and the second conduits,

FIG. 3 shows the fuel injector holes of the first conduit based on a preferred embodiment of the invention,

FIG. 4 illustrates a first embodiment of cross section of the combustor basket taken along the plane 2-2a of FIG. 1,

FIG. 5 illustrates a second embodiment of cross section of the combustor basket taken along the plane 2-2a of FIG. 1,

FIG. 6 illustrates a third embodiment of cross section of the combustor basket taken along the plane 2-2a of FIG. 1,

FIG. 7 illustrates the arrangement of the wall of the combustor basket,

FIG. 8 illustrates the rib structure of the cylindrical region of the combustor basket, and

FIG. 9 illustrates a transition and a flow conditioner arrangement according to an embodiment of the invention.

### DETAILED DESCRIPTION OF INVENTION

In general terms, a combustion turbine comprises three sections: a compressor section, a combustor section having a typical combustor basket and a turbine section. Air drawn into the compressor section is compressed. The compressed air from the compressor section flows through the combustor section where the temperature of the air mass is further increased after combustion of a fuel. From the combustor section the hot pressurized gas flow into the turbine section where the energy of the expanding gases is transformed into rotational motion of a turbine rotor that drives an electric generator.

The lower calorific value of the syngas fuels and the necessity to also operate the burner on a backup fuel like natural gas, significantly affects the design of the burners. The burner should be able to handle large fuel mass flows and the fuel passages consequently need to have a large capacity. A too small capacity results in a high fuel pressure drop. Due to the large fuel mass flow involved, a high pressure drop has a much larger impact on the total efficiency of the engine as compared to a typical natural gas fired engine.

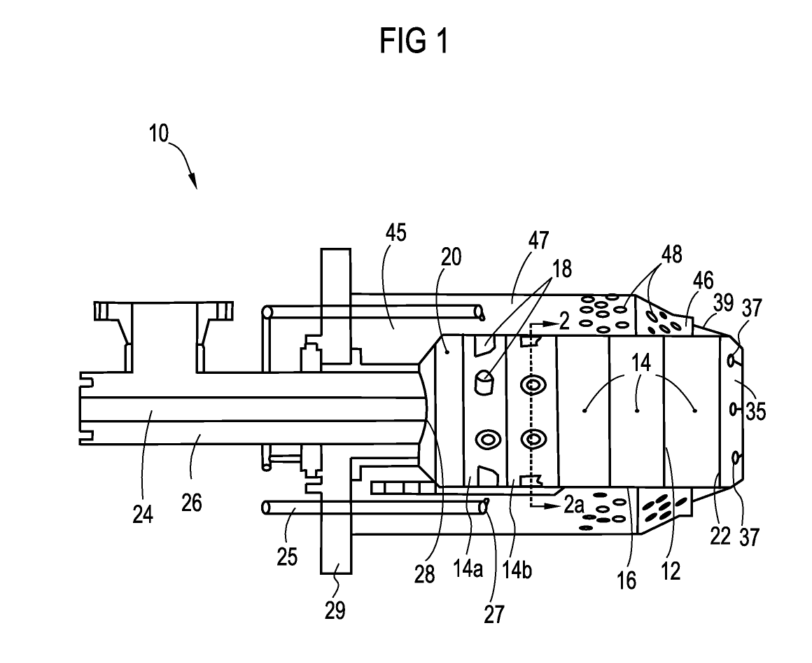

FIG. 1 illustrates a cross-sectional view of the multi-fuel combustion system 10 according to one embodiment of the invention. A multi-fuel combustion system 10 comprises a combustor basket 12. The wall 16 of the combustor basket 12 is made of multiple cylindrical regions 14 arranged to overlap each other at the transition and extends from an upstream end 20 to a downstream end 22 of the combustor basket. The upstream end 20 of the combustor basket is close to the region, where the fuel conduits generally supply the fuels for the combustion and the down stream end is the region, where the gas after combustion flows out to of the combustor basket to a turbine section. The combustion system 10 is designed to combust at least two type of fuels, for example natural gas and syngas. The types of fuels that could be used are not restricted to natural gas and syngas and hence the combustion system 10 could use other fuels for combustion.

FIG. 1 further shows a first conduit 24 adapted to provide a first type of fuel, for example natural gas, directly to the combustor basket 12 and the second conduit 26 is adapted to provide a second type of fuel, for example syngas directly to the combustor basket 12. Also there is at last one third conduit 25 adapted to inject at least one of the first type of fuel and the second type of fuel through one or multiple openings 18 into the combustor basket 12. The third conduit 25 is yet an optional choice. There could be more than one conduit to provide each type of fuel to the combustor basket based on the design and requirement. For example, there could be multiple third conduits 25 to supply the fuel through multiple openings 18 in the combustor basket 12. Also based on the mode of operation of the combustor basket 12, each of the conduits is adapted to handle a different fuel. Even the conduits could handle multiple fuels at the same point of time. The second conduit 26 is positioned to encircle the first conduit 24 or concentrically arranged for effective delivery of the fuels. The first conduit 24 is positioned coaxially, and internally, of a larger diameter second conduit 26. Since the diameter of the second conduit 26 is greater that the first conduit 24, the said second conduit 26 can handle low calorific value fuels of larger volumes since large fuel mass flows is needed to achieve a certain thermal power input.

Optional third conduit 25 is adapted to inject at least one of the first type of fuel and the second type of fuel into a compressor discharge air that flow through at least one of the openings 18 associated with at least one of the cylindrical regions 14. The third conduit 25 has a fuel injector nozzle 27 at the end having 1 to 5 injector holes that are aimed at an angle of 0 to 90° relative to a centerline of the opening 18. The first conduits 24 and the second conduit 26 under consideration consist of concentric circles of circular holes at the region of nozzle 28 of the conduits which acts as injectors for the fuels. The nozzle 28 helps to inject the respective fuels directly into the combustor basket 12 and is positioned at the upstream end 20 of the combustor basket 12.

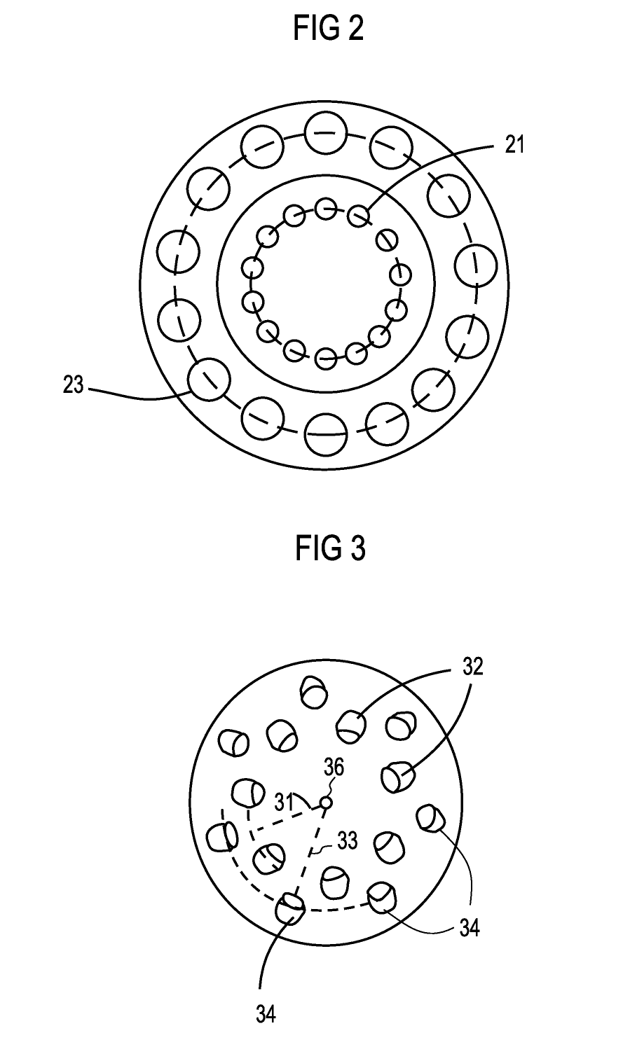

FIG. 2 shows explicitly these two rows of concentric holes at the region of nozzle 28. Each circle of rows is associated to a conduit. The inner row of holes 21 corresponds to the first conduit 24 and the outer row of holes 23 corresponds to the second conduit 26. The number of injectors in each conduit can vary, for example between 8 to 18 holes, but is not restricted to this numbers. A preferred embodiment having 14 injectors for both conduits is shown in FIG. 2. The holes can be clocked relative to each other or can be inline.

In another preferred embodiment, the holes in the region of nozzle 28 of the first conduit 24 comprises multiple holes positioned at, at least two different radial distances from the center of the nozzle for injecting a fuel flow into a region of combustion in the combustor basket 12. This nozzle design promotes a greater amount of fuel flow towards the center of the nozzle, which cools the nozzle in a cost effective and simple manner Most importantly the hole arrangement maintains the aerodynamic performance of the nozzle. FIG. 3 shows such a nozzle 30, of such a type used by the first conduit 24 to inject the fuel to the combustor basket 12. The first set of holes 32 and the second set of holes 34 are arranged at a first radial distance 31 and at a second radial distance 33 respectively from the center 36 of the nozzle.

Coming back to FIG. 1, the circumferential wall 16 of the combustor basket 12 comprises multiple openings 18. At least two of the cylindrical regions 14a and 14b nearer to the upstream end 20 of the combustor basket 12 further comprise multiple openings 18 distributed along the circumference of the respective cylindrical regions. This multiple openings 18 allow a compressor discharge air from a compressor stage to flow towards a region of combustion in the combustor basket. At the same time, at least one of the cylindrical region near to the downstream end 22 of the combustor basket 10 may also comprise plurality of openings 18 distributed along the circumference of the cylindrical region to allow the compressor discharge air to flow towards a region of combustion in the combustor basket 12.

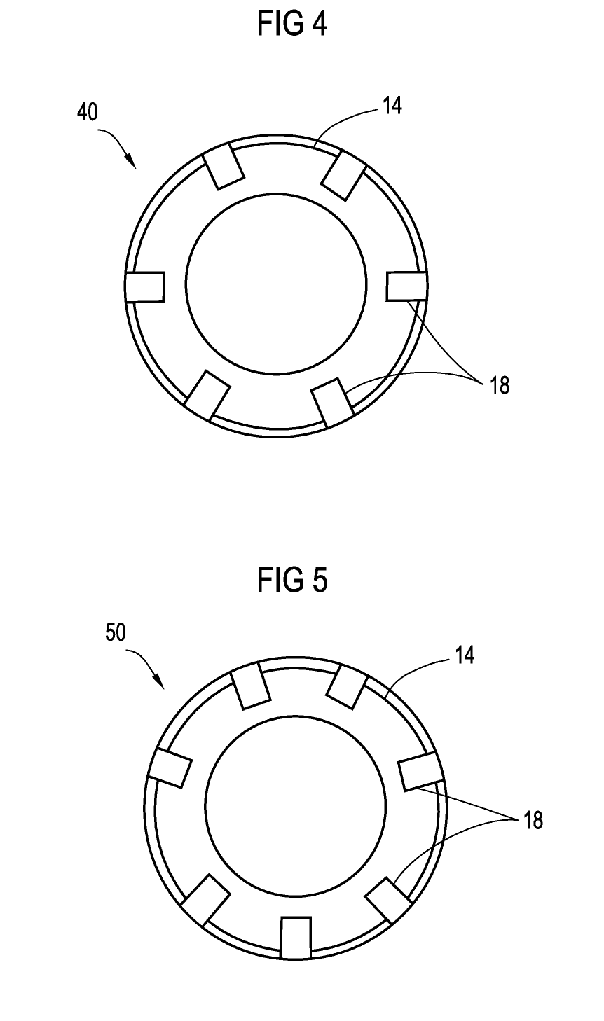

FIG. 4 illustrates a first embodiment 40 of cross section of the combustor basket 12 taken along the plane 2-2a of FIG. 1. The number of openings in the individual cylindrical region 14 varies between 5 and 9 based on the embodiments. FIG. 4 shows 6 numbers of openings 18 in the circular region 14 of the combustor basket 12.

FIG. 5 illustrates a second embodiment 50 of cross section of the combustor basket taken along the plane 2-2a of FIG. 1. FIG. 5 shows 7 numbers of openings 18 in the circular region 14 of the combustor basket 12.

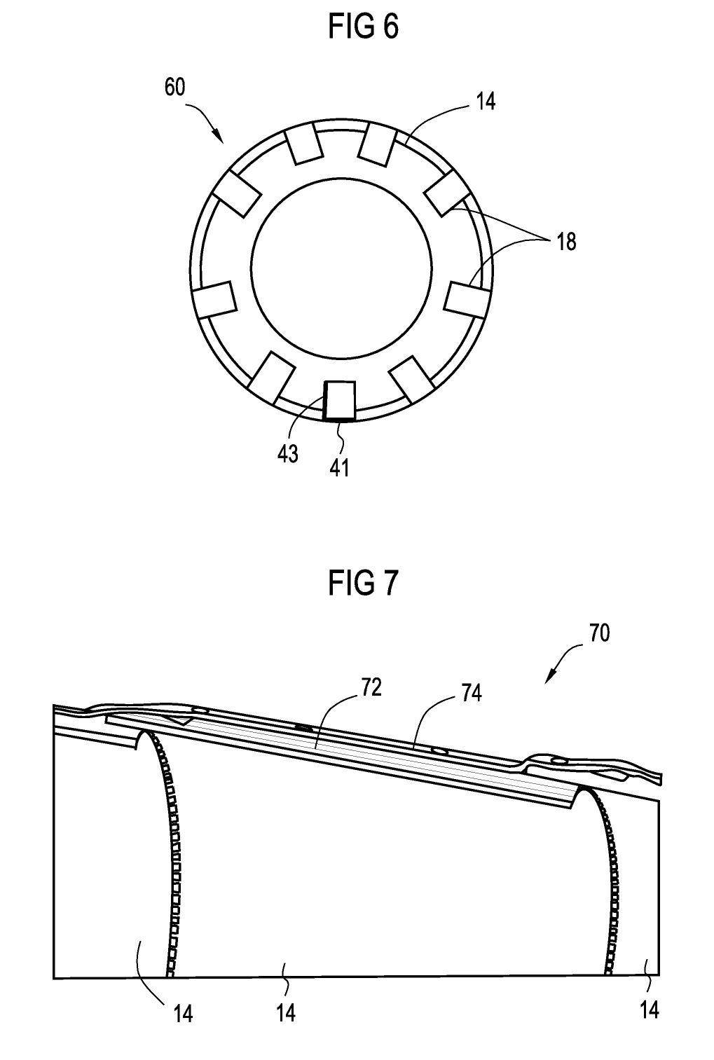

FIG. 6 illustrates a third embodiment 60 of cross section of the combustor basket 12 taken along the plane 2-2a of FIG. 1. FIG. 6 shows 9 numbers of openings 18 in the circular region 14 of the combustor basket 12. These openings in the combustor basket are like scoops, especially radial scoops through which compressor discharge air is injected in the combustor basket 12. The openings are alternatively referred to as scoops in few places in the description for convenience.

At a minimum, the length of the scoops is half the diameter of the scoop. For example, FIG. 6 shows an opening 18, having a length 43 and a diameter 41. This length is oriented to the interior region of the combustor basket 12. This length helps to lead the air further into the combustion region. The scoops deliver air flow with greater penetration into the fuel stream, achieving improved heating efficiency and more complete combustion. The openings 18 are equally distributed along the circumference of the cylindrical region 14. Odd numbers of openings are beneficial for wall temperatures and helps against thermo-acoustic problems, since they provide a rotational asymmetrical configuration. The scoops can be circular or oval in cross-section. When the scoops are oval, the smallest dimension of the oval shape lies in the direction of the basket centerline. The scoops can have an angle of 0-45° relative to the radial direction, from the basket centerline and aiming downstream when angled. In a particular layout, few or all the scoops in a cylindrical region can have an angle of 15°, whereas few or all the scoops in another cylindrical region can have an angle of 0°, i.e. aimed radial towards the center line. In addition, the scoops can be directed against the flow of thrust of the combustor system with an angle up to 15° relative to radial direction. In another alternate embodiment, the downstream edges of the scoops are cut-off at an angle between 0-60° relative to the centerline of the combustor basket. This is basically to avoid damages caused by the recirculation of hot air to the scoops.

The combustion system 10 further comprises a cover plate 29 coupled to the combustor basket 12 and the first, second and third conduits. This enables the combustor basket and the conduits to be attached to a casing.

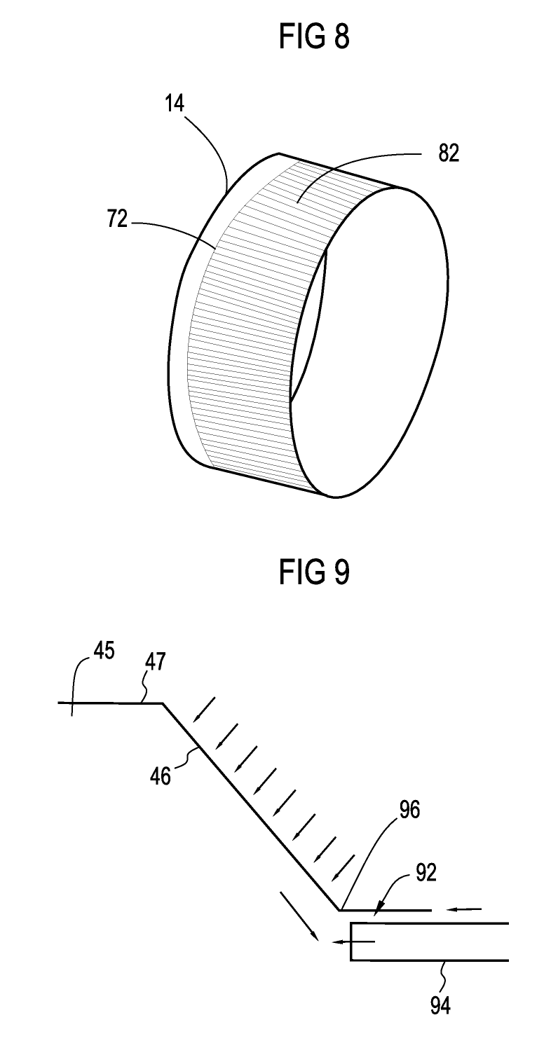

FIG. 7 illustrates the arrangement 70 of the wall 16 of the combustor basket. As mentioned, the wall 16 of the combustor basket 12 is made of a plurality of cylindrical regions 14 arranged to overlap each other at the transition. The individual cylindrical region 14 comprises an outer surface 72, said outer surface 72 is provided with a rib structure 82 as shown in FIG. 8. The outer surface 72 is covered substantially by a perforated layer 74 adapted to provide an air flow for cooling the wall 16. The wall 16 of the combustor basket 12 is cooled by convection and effusion cooling. To increase the effectiveness of the cooling method, so-called plate fin design as shown in FIG. 7 is used. These plate fins consist of two liners. The inner liner, which is basically the cylindrical region is provided with the cooling rib structure 82 in the outer surface 72 to increase the cooling surface. The outer liner is the perforated layer 74. When the cooling air exits the plate fin, it serves as effusion cooling air.

The multi-fuel combustion system 10 further comprises a flow conditioner 45 positioned to encircle the combustor basket 12 and having a conical section 46 and a cylindrical section 47 having plurality of holes 48 adapted to allow the compressor discharge air to flow towards a region of combustion in the combustor basket 12. The flow conditioner 45 is used to achieve the pressure drop required for cooling and to provide a uniform air flow towards the region of combustion in the combustor basket 12. Holes 48 in both the cylindrical section 47 and the conical section 46 are used as flow passage for air.

In addition, as shown in FIG. 9, a gap 92 exists between the transition 94 and the end 96 of the conical section 46 of the flow conditioner 45. The flow conditioner 45 slightly overlaps the transition 94. In this way thermal expansion does not affect the flow area of the gap 92. The conical section 46 and a cylindrical section 47 is connected together by a flange or could be welded together.

The multi-fuel combustion system 1 of FIG. 1 further comprises an exit cone 35 at the downstream end 22 of the combustor basket 12 having multiple slots 37 aligned to the plurality of openings 18 associated with at least one of the cylindrical regions 14. This exit cone 35 is intended to improve the mixing between the hot combustion gasses and the cold air flow coming out of a spring-clip passage 39. The improved mixing between these flows lead to better CO emissions. The exit cone slots 37 aligned with the scoops 18 prevent overheating of the exit cone 35.

The method of operating the multi-fuel combustion system 10 is now described. The operation could be divided into two main phases a first phase and a second phase. During the first phase an ignition is provided to a combustor basket by an ignition coil to ignite a first type of fuel, for example natural gas supplied to the combustor basket 12 through the first conduit 24. The method also involves supplying steam to the first conduit 24 in addition to the first type of fuel and supplying steam to the second conduit 26 after the ignition. Steam is provided to the second conduit 26 at a time earlier than the steam provided to the first conduit 24. The method further involves supplying a medium, for example an inert gas, nitrogen, steam or seal air to the second conduit 26 during the first phase for stabilizing the combustion system 10 for any pressure difference in the combustor basket 12. In a typical industrial arrangement the combustion system or the turbine comprises a plurality of combustor baskets, and while in operation there could be pressure differences that could be built up between these combustor baskets. The supply of the medium also takes care of this pressure difference in the combustor basket due to this type of arrangement. The supply of the medium in the second conduit 26 is shut off once the steam supply is stabilized in the first conduit 24 and the second conduit 26 during the first stage of operation.

In the second phase of operation, a second type of fuel for example syngas is supplied to the combustor basket through the second conduit 26, while stopping the supply of the first fuel. The method further comprises supplying a portion of the second type of fuel to the combustor basket 12 through the first conduit 24 during the second phase. The steam is continuously supplied in the first conduit 24 from the first phase until the beginning of supplying the portion of the second type of fuel through the first conduit 24 during the second phase. Also the third conduit 25 may also be used to supply any one of the first or second type of fuel for enabling an effective and more complete combustion by introducing the said fuels through the openings 18 if required. This further helps in reducing NOx emissions.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

1-21. (canceled)

22. A multi-fuel combustion system comprising:
a combustor basket adapted to combust at least two type of fuels, the combustor basket having a circumferential wall comprising a plurality of openings to guide a flow of air into the combustor basket;
a first conduit adapted to provide a first type of fuel directly to the combustor basket;
a second conduit adapted to provide a second type of fuel directly to the combustor basket; and
a third conduit adapted to inject at least one of the first type of fuel and the second type of fuel through at least one of the openings into the combustor basket.

23. A multi-fuel combustion system comprising:
a combustor basket adapted to combust at least two type of fuels, the combustor basket having a circumferential wall comprising a plurality of openings to guide a flow of air into the combustor basket;
a first conduit adapted to provide a first type of fuel directly to the combustor basket; and
a second conduit adapted to provide a second type of fuel directly to the combustor basket.

24. The multi-fuel combustion system according to claim 22, wherein the wall of the combustor basket is made of a plurality of cylindrical regions arranged to overlap each other at the transition and extends from the upstream end to the downstream end of the combustor basket.

25. The multi-fuel combustion system according to claim 24, wherein an individual cylindrical region comprises an outer surface, the outer surface is provided with a rib structure and is covered by a perforated layer adapted to provide an air flow for cooling the walls.

26. The multi-fuel combustion system according to claim 24, wherein at least two of the cylindrical regions at the upstream side of the combustor basket further comprise the plurality of openings distributed along the circumference of the cylindrical region to allow a compressor discharge air to flow towards a region of combustion in the combustor basket.

27. The multi-fuel combustion system according to claim 24, wherein at least one of the cylindrical regions at the downstream side of the combustor basket further comprises the plurality of openings distributed along the circumference of the cylindrical region to allow the compressor discharge air to flow towards a region of combustion in the combustor basket.

28. The multi-fuel combustion system according to claim 24, wherein the individual cylindrical region comprises between 5 and 9 openings.

29. The multi-fuel combustion system according to claim 28, wherein the individual cylindrical region comprises an odd number of openings.

30. The multi-fuel combustion system according to claim 22, wherein the first type of fuel is natural gas.

31. The multi-fuel combustion system according to claim 22, wherein the second type of fuel is syngas.

32. The multi-fuel combustion system according to claim 22,
wherein the first conduit comprises a nozzle to supply at least one of the first type of fuel and the second type of fuel directly to the combustor basket for combustion, and
wherein the nozzle comprises a plurality of holes positioned at, at least two different radial distances from the center of the nozzle for enabling a fuel flow into a region of combustion in the combustor basket.

33. The multi-fuel combustion system according to claim 22, further comprising an exit cone at the downstream end of the combustor basket,
wherein the exit cone comprises of plurality of slots aligned to the plurality of openings associated with at least one of the cylindrical regions.

34. The multi-fuel combustion system according to claim 22, further comprising a flow conditioner positioned to encircle the combustor basket and having a conical section and a cylindrical section having plurality of holes adapted to allow the compressor discharge air to flow towards a region of combustion in the combustor basket.

35. The multi-fuel combustion system according to claim 22, further comprising a cover plate coupled to the combustor basket and the conduits, such that the combustor basket and the conduits are attached to a casing using the cover plate.

36. The multi-fuel combustion system according to claim 22, wherein the first conduit and the second conduit are concentrically arranged for effective delivery of the first type of fuel and the second type of fuel to the combustor basket.

37. The multi-fuel combustion system according to claim 22, wherein the third conduit is adapted to inject at least one of the first type of fuel and the second type of fuel into a compressor discharge air that flow through at least one of the openings associated with at least one of the cylindrical regions.

38. The multi-fuel combustion system according to claim 22, wherein the third conduit further comprises an injector nozzle having at least one hole to inject at least one of the first type of fuel and the second type of fuel into a compressor discharge air that flow through at least one of the openings associated with at least one of the cylindrical regions.

39. A method of operating a multi-fuel combustion system including a first phase and a second phase, the method comprising:
providing the first phase, which comprises:
providing ignition to a combustor basket to ignite a first type of fuel, where the first type of fuel is supplied to the combustor basket through a first conduit, and
supplying steam to the first conduit in addition to the first type of fuel and supplying steam to the second conduit after the ignition; and
providing the second phase, which comprises:
supplying a second type of fuel to the combustor basket after ignition of the first fuel through the second conduit, while stopping the supply of the first fuel.

40. The method according to claim 39, further comprising supplying a portion of the second type of fuel to the combustor basket through the first conduit during the second phase.

41. The method according to claim 39, wherein the first type of fuel is natural gas and the second type of fuel is syngas.
